(19) United States
(12) Patent Application Publication
(10) Pub. No.: US 2023/0243232 A1
(43) Pub. Date: Aug. 3, 2023

(54) PRINTED ANNULAR METAL-TO-METAL SEAL

(71) Applicant: Baker Hughes Oilfield Operations LLC, Houston, TX (US)

(72) Inventors: Laura Walker, Houston, TX (US); Keith Adams, Katy, TX (US); Brian Munk, Houston, TX (US); Lauren Valera, Houston, TX (US); Mahesha Udipi, Houston, TX (US)

(73) Assignee: Baker Hughes Oilfield Operations LLC, Houston, TX (US)

(21) Appl. No.: 17/587,774

(22) Filed: Jan. 28, 2022

(51) Int. Cl. E21B 33/12

(52) U.S. Cl. CPC E21B 33/1212; B33Y 80/00

(57) ABSTRACT

A metal-to-metal seal for sealing an annular space between a well casing and a wellbore. The seal includes a first end, a second end, and a central seal portion. The central seal portion has a concave shape in a de-energized state which curves towards the centerline of the seal and is capable of flexing radially outward towards surface of the annular space when energized. The central seal portion further includes at least one outer ridge extending outward away from the centerline of the seal and sealingly engages with the outer annular surface when energized.

### BACKGROUND

### Field of Invention

This invention relates in general to fluid control in annular spaces, and more particularly, to annular seals to prevent fluid movement through an annular space.

### Description of the Prior Art

Oil and gas field operations typically involve drilling and operating wells to locate and retrieve hydrocarbons. A completed well typically includes multiple annular spaces between various components. These can include annuli between production tubing and production casing, between different levels of casing, and finally between the outermost casing and the formation. The annuli are named starting at the inner-most annulus, which is designated the A-annulus, with increasing alphabetical designations for each annulus moving outward.

At times during the life of a well, it can be necessary to plug one or more of the annuli at certain locations both permanently and temporarily. This can be done to prevent fluid communication in different sections of the well and can be used both for maintenance and environmental purposes. The annular seals are often placed using a casing hanger system in order to position them at certain depths of the well.

Current annular seals have a number of deficiencies which can limit their effectiveness. Exposed sealing ridges can contact both the inner and outer surfaces of the annulus during the process of positioning the seal in the annular space. This can result in damage both to the surfaces of the annular space as well as the sealing ridges which can lead to incomplete sealing upon activation. When in position, current annular seals often require large mechanical forces to energize and seal the annular space. Further, repeated sealing in the same location can cause wear on the inner and outer annular walls. This can result in incomplete sealing at the same location over time.

### SUMMARY

One embodiment of the present technology provides for an annular metal-to-metal seal including a first seal end, a second seal end, and a central seal portion. In some embodiments the central seal portion can have a concave shape in a de-energized state that curves towards a centerline of the seal. In other embodiments, the central seal portion can be capable of flexing radially outward upon energization of the seal. In alternate embodiments there can be at least one outer ridge extending radially outward from the central seal portion away from the centerline of the seal. In some embodiments, the at least one outer ridge can sealingly engage with an outer annular surface when energized.

In alternate embodiments, there can be at least one inner ridge extending radially outward from the central seal portion away from the centerline of the seal. In some embodiments, the at least one inner ridge can sealingly engage with the inner annular surface when energized.

In some embodiments, there can be outer and inner concave central seal surfaces which define a recess between the two central seal surfaces. In other embodiments, there can be at least one intra-seal ridge extending from the outer concave central seal portion. In some embodiments, the at least one intra-seal ridge can sealingly engage with a plunger when energized.

In alternate embodiments, there can be at least one central ridge extending from the inner concave central seal portion. In some embodiments, the at least one central ridge can sealingly engage with a plunger when energized.

In other embodiments, the at least one outer ridge can include a plurality of outer ridges. In some embodiments, the plurality of ridges can be positioned at predetermined locations along the central portion of the seal. In alternative embodiments, this positioning can change the seal profile when the seal is reversed in the annular space.

In some embodiments, the seal can include a plunger inserted into the recess between the inner and outer concave central seal surfaces. In other embodiments, the plunger has a larger diameter than the diameter of the recess. In alternative embodiments, the plunger can energize the seal when inserted into the recess.

In other embodiments, the seal can be made with additive manufacturing. In some embodiments the ridges can be a different material of construction than the central portion of the seal.

A second embodiment of the present technology provides for a method for sealing an annular space of a well. In some embodiments, a metal-to-metal annular seal can be inserted into the annular space. In some embodiments, the seal can have inner and outer biased concave central sealing surfaces. In other embodiments, a plunger can be inserted into the first end of the annular seal. In alternative embodiments, the plunger can energize the inner and outer biased concave central sealing surfaces of the annular seal by pushing the surfaces towards the annular surfaces within the annular space. In some embodiments, this can result in sealing engagement between the inner and outer biased concave central sealing surfaces and the annular surfaces of the annular space.

In other embodiments, there can be ridges on the inner and outer biased concave central sealing surfaces. In alternate embodiments these ridges can sealingly engage with the annular surfaces of the annular space. In some embodiments, the seal can be test after engaging the sealing surfaces to test for a proper seal. In these embodiments, additional sealing surfaces can be engaged if it is determined that the annular space is not properly sealed.

In other embodiments, there can be at least one intra-seal ridge that contact the plunger when the seal is energized. In some embodiments, the plunger can be tapered or bulbous to selectively engage the sealing surfaces of the seal.

A third embodiment of the present technology provides for a method for resealing an annular space. In some embodiments, the plunger can be removed from the first end of the annular metal-to-metal seal and the seal can be removed from the annular space. In other embodiments the seal can be reoriented relative to the annular space. In alternate embodiments, the reoriented seal can be reinserted into the annular space. In some embodiments, the plunger can be inserted into the open end of the seal to re-energize the seal.

In other embodiments, a seal cap can be moved from the first end of the annular seal to the second end of the annular seal prior to reinsertion of the seal into the annular space. In alternative embodiments, the plunger can be inserted from below the seal after the seal has been reinserted into the annular space.

In some embodiments, the seal can be placed in a substantially similar in the annular space both before removal and after re-insertion. In other embodiments, the ridges can engage in substantially different locations before removal and after re-insertion into the annular space.

### BRIEF DESCRIPTION OF THE DRAWINGS

The present technology will be better understood on reading the following detailed description of non-limiting embodiments thereof, and on examining the accompanying drawings, in which:

FIG. 1 is a schematic view of an embodiment of a system that includes a production tubular and injection apparatus.

FIG. 2 is an isometric view of a sample annular metal-to-metal seal.

FIG. 3 is a schematic cross-sectional view of a sample annular metal-to-metal seal prior to the insertion of a plunger.

FIG. 4A is a schematic cross-sectional view of a sample annular metal-to-metal seal after a plunger has been inserted into the open first end of the seal.

FIG. 4B is a schematic cross-sectional view of a sample annular metal-to-metal seal with plunger fully inserted into the seal.

FIG. 5A is a schematic cross-sectional view of a sample embodiment of an annular metal-to-metal seal with a tapered plunger partially inserted.

FIG. 5B is a schematic cross-sectional view of a sample embodiment of an annular metal-to-metal seal with a tapered plunger fully inserted.

FIG. 6 is a schematic cross-sectional view of a sample embodiment of an annular metal-to-metal seal with a tapered plunger and additional sealing ridges.

FIG. 7A is a block diagram of steps to seal an annular space using an annular metal-to-metal seal.

FIG. 7B is a block diagram of steps to unseal an annular space using an annular metal-to-metal seal.

FIG. 7C is a block diagram of steps to reseal an annular space using the same annular metal-to-metal seal.

FIG. 8 is a schematic cross-sectional view of a sample embodiment of an annular metal-to-metal seal with a bulbous plunger partially inserted.

### DETAILED DESCRIPTION

The foregoing aspects, features and advantages of the present technology will be further appreciated when considered with reference to the following description of preferred embodiments and accompanying drawings, wherein like reference numerals represent like elements. In describing the preferred embodiments of the technology illustrated in the appended drawings, specific terminology will be used for the sake of clarity. The present technology, however, is not intended to be limited to the specific terms used, and it is to be understood that each specific term includes equivalents that operate in a similar manner to accomplish a similar purpose.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments. Additionally, it should be understood that references to “one embodiment”, “an embodiment”, “certain embodiments,” or “other embodiments” of the present invention are not intended to be interpreted as excluding the existence of additional embodiments that also incorporate the recited features. Furthermore, reference to terms such as “above,” “below,” “upper”, “lower”, “side”, “front,” “back,” or other terms regarding orientation are made with reference to the illustrated embodiments and are not intended to be limiting or exclude other orientations.

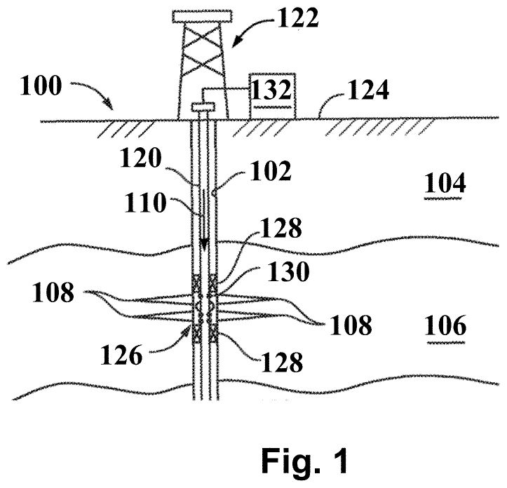

Referring initially to FIG. 1, there is shown an exemplary wellbore system 100 that includes a wellbore 102 drilled through an earth formation 104 and into a production zone or reservoir 106. The wellbore 102 is shown lined with a casing having a number of perforations 108 that penetrate and extend into the formation production zone 106 so that formation fluids or production fluids may flow from the production zone 106 into the wellbore 102. The wellbore 102 includes a string (or production tubular) 110 that includes a tubular (also referred to as the “tubular string” or “base pipe”) 110 that extends downwardly from a wellhead 122 at surface 124 of the wellbore 102. An annulus 120 is defined between the string 110 and the wellbore 102, which may be an open or cased wellbore.

Injection assembly 126 is positioned at selected locations along the string 110. Each injection assembly 126 may be isolated within the wellbore 102 by a pair of annular seals 128. Although only one injection assembly 126 is shown, any appropriate number of such injection assemblies 126 may be arranged along the string 110. Annular seals 128 isolate discrete portions of the annulus 120, thereby enabling pressure manipulation to control fluid flow in wellbore 102.

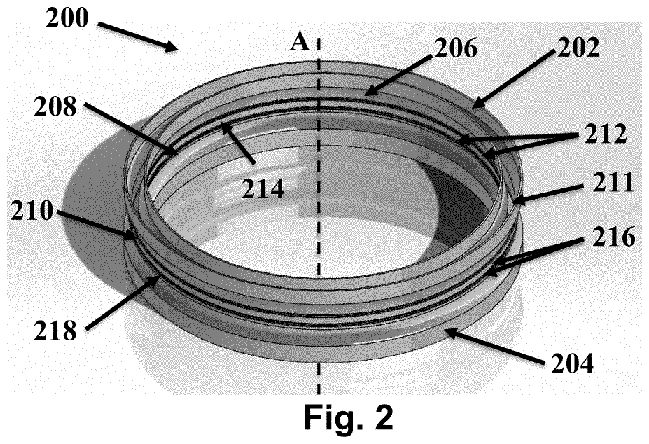

Referring now to FIG. 2, an annular metal-to-metal seal 200 is pictured. The seal has a first end 202 and second end 204 and a central portion 206, as well as an inner generally cylindrical surface 208 and an outer generally cylindrical surface 210. The seal generally circumscribes a central axis A. The outer surface 210 has a greater radius than the inner surface 208. First end 202 of the seal can define a recess 211 in the central portion 206 between the inner surface 208 and outer surface 210 of the seal. Both the inner 208 and outer 210 surfaces are generally concave, with the outer surface 210 of central portion 206 curving generally inwardly toward the axis A of the seal 200 and the inner surface 208 of central portion 206 curving generally outwardly away from the axis A of the seal 200 between the first end 202 and the second end 204 of the seal.

As also shown in FIG. 2, the inner surface 208 of the seal can include inner ridges 212. The inner ridges 212 can be positioned on the inner concave central surface 214 of the central portion 206 of the seal and protrude from the inner concave central surface 214 of the seal toward the central axis A. Similarly, the outer surface 210 of the seal can include outer ridges 216. The outer ridges 216 can be positioned on the outer concave central surface 218 of the central portion 206 of the seal and protrude from the outer concave central surface 218 of the seal away from the axis A. This positioning of the ridges 212, 216 on the concave central surfaces 214, 218 of the seal helps to protect the ridges 212, 216 from contacting a casing or other tubular during setting of the seal.

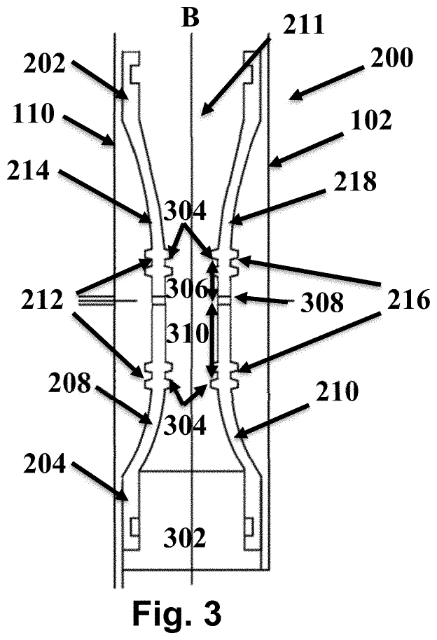

FIG. 3 shows a schematic cross-sectional view of the annular metal-to-metal seal 200. FIG. 3 provides additional detail of the second end 204 of the seal, including a seal cap 302. The seal cap 302 can help to properly position the seal relative to the plunger (discussed below) and connects the inner surface 208 with the outer surface 210 of the seal 200. The seal cap 302 can also or alternatively be installed on the first end 204 of the seal. This results in the seal 200 being reversable in the annular space.

Alternatively, the seal cap 302 can be an integral component of the seal 200 such that it cannot be removed. In this alternative configuration, the seal cap 302 may not be able to be moved to the first end 204 of the seal 200.

In FIG. 3, the ridges 212, 216 are also shown in particular axial locations along the concave central surfaces 214, 218 of the seal, and additional corresponding intra-seal ridges 304 are shown on inner surfaces of the recess 211. The intra-seal ridges 304 face inward towards a centerline B of the recess 211.

In the particular embodiment shown in FIG. 3, the distance 306 between a centerline 308 of the seal and the ridges 212, 216, 304 located toward the first end 202 of the seal is less than the distance 310 between the centerline 308 of the seal and the ridges 212, 216, 304 located toward the second end 204 of the seal. If the seal is reoriented in the annular space, the distances 306 and 310 may also be reoriented, resulting in different sealing locations upon energization of the seal between the ridge 212, 216 and the string 110 and wellbore 102 than before the reorientation.

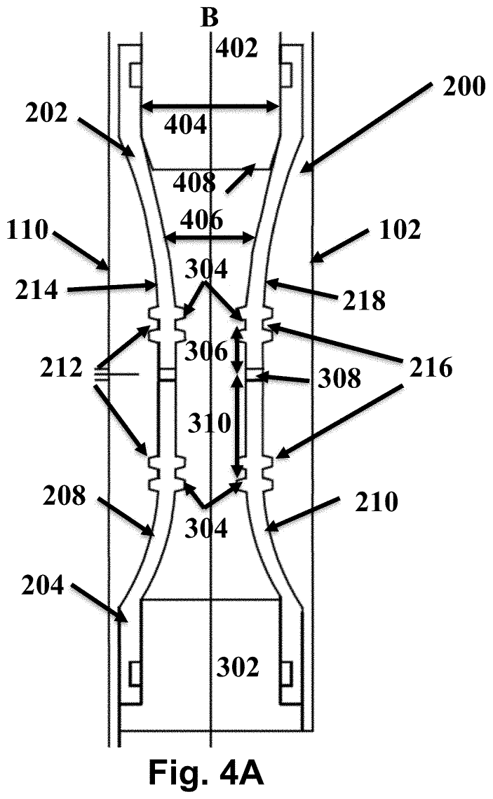

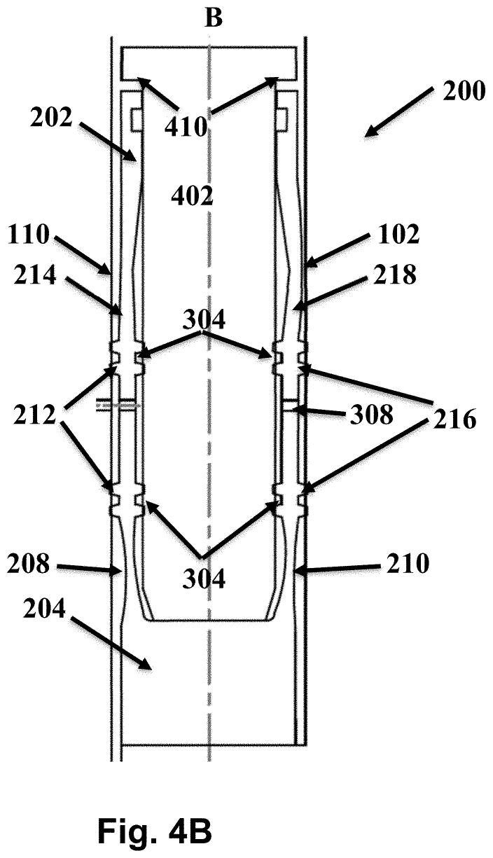

FIG. 4A shows the seal in a de-energized state before a plunger 402 energizes the seal. The diameter of the plunger 402 can be substantially equal to the diameter 404 of the recess 211 at the first end 202 of the seal. The generally concave shape of the concave central surfaces 214, 218 of the seal results in a smaller diameter 406 between the concave central surfaces 214, 218 of the seal than the diameter 404 of the plunger 402. As such, when the plunger 402 moves between the concave central surfaces 214, 218 of the seal, the inner and outer surfaces 208, 210 of the seal are pushed radially outward away from the centerline B of the recess 211. This results in the energization of the seal, shown in FIG. 4B.

The plunger 402 can have a tapered end 408. The tapered end 408 can result in requiring less force to insert the plunger 402 into the first end 202 of the seal. Additionally, the tapered end 408 can also reduce the energy required to energize the seal as the plunger 402 passes between the concave central surfaces 214, 218 of the seal.

FIG. 4B shows the seal after the plunger 402 energizes the seal. Here, the inner and outer surfaces 208 and 210 have been pushed radially outward relative to the centerline B of the recess 211 by the plunger 402. As the plunger 402 pushes through the seal, intra-seal ridges 304 engage in sealing contact with the surfaces of the plunger 402. At the same time, ridges 212, 216 have been pushed by the plunger 402 radially toward the string 110 and wellbore 102 until the ridges 212, 216 engage in sealing contact with the string 110 and wellbore 102. In some embodiments, a plunger lip 410 can be provided to prevent the plunger from moving past a predetermined point relative to the first end 202 of the seal. This can help to prevent the plunger 402 from passing through the seal during energization.

Alternatively, the plunger can enter the seal 200 from below instead of from above as shown in FIG. 4A. This can occur when the seal 200 is reorientated in the annular space and has an integral second end instead of a seal cap 302. In this embodiment, the plunger 402 can energize the seal 200 in the same way as described above. The first end 202, however, is oriented towards the bottom of the annular space instead of towards the top as shown in FIG. 4A.

When it is desired to de-energize the seal, the reverse process occurs. The plunger 402 is removed from the seal. The central portion 206 of the seal can be biased so that without the plunger 402 the concave central surfaces 214, 218 return to the generally concave positions shown in FIG. 4A. This results in the ridges 212, 216 moving out of sealing engagement with the string 110 and wellbore 102. Once the plunger 402 is completely removed from the annular seal and the seal has returned to the position in FIG. 4A, the seal can be removed from the annular space. Upon removal of the seal, the ridges 212, 216 are once again protected from contact with the string 110 and wellbore 102 of the annular space due to the return of the concave central surfaces 214, 218 to their generally concave positions. Since the seal retains the same shape both before and after sealing an annular space, the seal can be reused multiple times. Reuse in the same location is eased by flipping the seal and positioning in the same location of the annular space, which, as discussed above, results in changed locations of the ridges 212, 216 relative to the string 110 and wellbore 102.

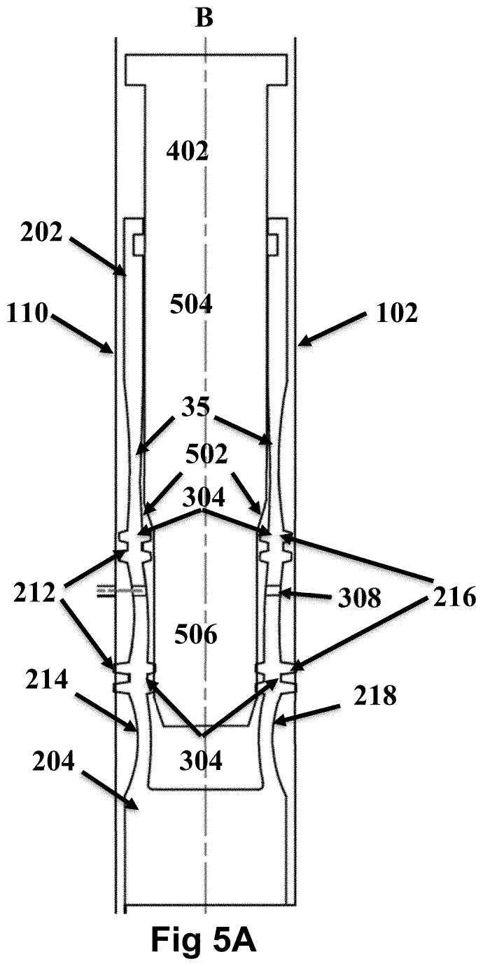

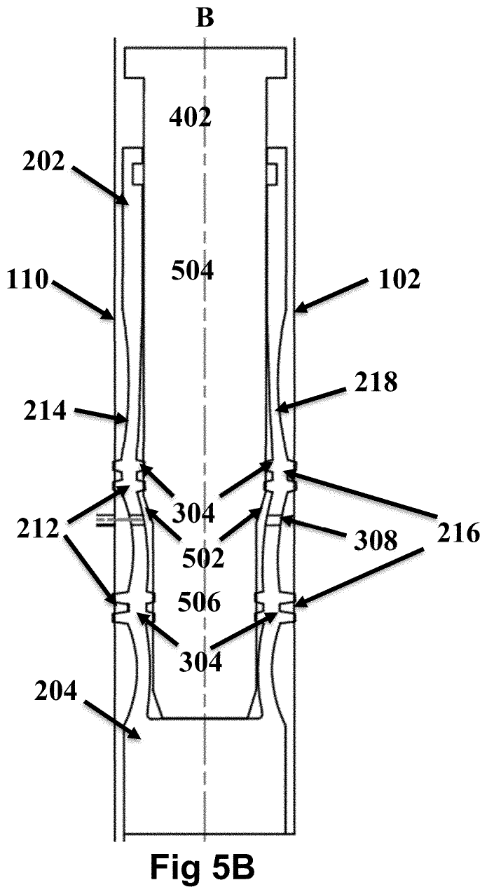

FIGS. 5A and 5B show an alternate embodiment of an annular seal and plunger configuration. In this embodiment, the ridges 212, 216, 304 located above the centerline 308 and towards the first end 202 of the seal can be smaller than the ridges 212, 216, 304 located below the centerline 308 and towards the second end 204 of the seal. Additionally, the plunger 402 can include a midpoint taper 502 such that the upper end 504 of the plunger 402 can have a greater diameter than the lower end 506 of the plunger 402. This can result in selective energization of different sealing ridges 212, 216, 304 during insertion of the plunger 402 based on the size of the different ridges 212, 216, 304 and location of the midpoint taper 502 on the plunger.

FIG. 5A shows this alternate embodiment in a semi-energized configuration. In this configuration, the plunger 402 can be partially inserted into the seal such that the midpoint taper 502 has not moved past the ridges 212, 216, 304 above the centerline 308 and toward the first end 202 of the seal. As a result, the plunger 402 has not yet contacted the ridges 212, 216, 304 above the centerline 308 due to the smaller ridge size when compared to the ridges 212, 216, 304 below the centerline 308 and towards the second end 204 of the seal. In this embodiment, the ridges 212, 216, 304 above the centerline 308 of the seal are not sealingly engaged with the plunger 402, the string 110, or the wellbore 102.

The ridges 212, 216, 304 below the centerline 308 can be in contact with the lower end 506 of the plunger 402 since the ridges 212, 216, 304 below the centerline 308 can be larger than the ridges 212, 216, 304 above the centerline 308 of the seal. This contact can cause the concave central surfaces 214, 218 below the centerline 308 to be pushed radially outward relative to the centerline B of the recess 211 by the plunger 402. As a result, the ridges 212, 216, 304 below the centerline 308 of the seal can be sealingly engaged with the plunger 402, the string 110, and the wellbore 102, while the ridges 212, 216, 304 above the centerline 308 of the seal need not be sealingly engaged with the plunger 402, the string 110, or the wellbore 102. In other words, the shape of the plunger 402, the position of the plunger 402 in the recess 211, and the size of the ridges 212, 216, 304 can be manipulated to effect sealing engagement between seal surfaces, the plunger 402, the string 110, and the wellbore 102 in different ways depending on the requirements of a particular drilling operation.

In the configuration of FIG. 5A, the annular seal can be tested with only the ridges 212, 216, 304 below the centerline 308 of the seal sealingly engaged to determine if the configuration is sufficient to seal the annular space. If, upon testing, the annular space is not sealed, or if more assurance of sealing is needed, the plunger 402 can continue into the annular seal to the position depicted in FIG. 5B.

FIG. 5B shows the annular seal in a fully energized configuration. The plunger 402 can continue into the seal such that the midpoint taper 502 can pass the ridges 212, 216, 304 above the centerline 308 of the seal. This can result in contact between the ridges 212, 216, 304 above the centerline 308 and the plunger 402 which can cause the concave central surfaces 214, 218 above the centerline 308 to be pushed radially outward relative to the centerline B of the recess 211 by the plunger 402. In this way, the ridges 212, 216, 304 above the centerline 308 of the seal can be sealingly engaged with the plunger 402, the string 110, and the wellbore 102. At the same time, the ridges 212, 216, 304 below the centerline 308 of the seal remain sealingly engaged with the plunger 402, the string 110, and the wellbore 102, similar to FIG. 5A. The midpoint taper 502 may not be able to move past the ridges 212, 216, 304 below the centerline 308 such that they are similarly engaged as in FIG. 5A.

In configuration of FIG. 5B, ridges 212, 216, 304 of the seal can be sealingly engaged with the plunger 402, the string 110, and the wellbore 102, thereby sealing the annular space. The annular seal can be de-energized and removed from the annulus by removing the plunger 402 from the first end 202 of the seal. Without the plunger 402, the concave central surfaces 214, 218 return to their generally concave positions. This results in the ridges 212, 216 moving out of sealing contact with the string 110 and wellbore 102. Once the plunger 402 is completely removed from the annular seal, the seal can be removed from the annular space. The ridges 212, 216 are once again protected from contact with the string 110 and wellbore 102 of the annular space during removal of the seal due to the generally concave shape of the concave central surfaces 214, 218. Since the seal retains the same shape both before and after sealing the annular space, the seal can be reused multiple times.

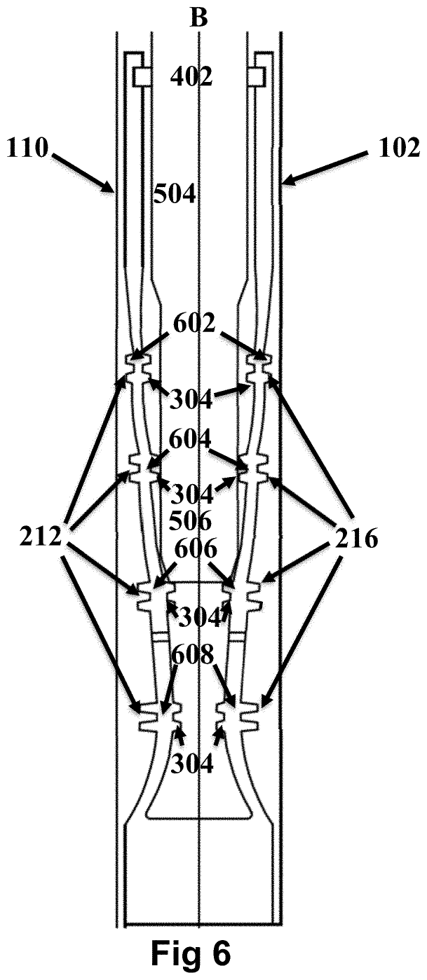

FIG. 6 shows an alternate embodiment with multiple sets of ridges of variable size on the annular seal, and a tapered or stepped plunger 402 similar to that shown in FIGS. 5A and 5B. In the example embodiment shown, the seal can include a first set of ridges 602, a second set of ridges 604, a third set of ridges 606, and a fourth set of ridges 608, although any appropriate number of ridges can be used. Each set of ridges includes inner ridges 212, outer ridges 216, and inter-seal ridges 304. In this embodiment, the first and second set of ridges 602, 604 are smaller ridges. The third and fourth set of ridges 606, 608 are larger. The sizes of the individual ridge sets can by varied according to the desired energization sequence of the seal.

In FIG. 6, the seal is currently in a deenergized position as none of the ridge sets 602, 604, 606, 608 have engaged with the plunger 402. Energization of the first and second ridge sets 602, 604 can occur when the upper end 504 of the plunger 402 engages with the ridge sets 602, 604. Energization of the third and fourth ridge sets 606, 608 can occur when the lower end 506 of the plunger 402 engages with the ridge sets 606, 608. When fully energized, the embodiment provides for four sets of sealing surfaces with the string 110 and wellbore 102. Additionally, the plunger 402 can be removed from the annular seal so that the seal can be removed from the annular space when sealing is no longer needed and reused as required.

The annular seals can be made using additive manufacturing. Additive manufacturing can allow for the creation of the detailed ridges that form the sealing surfaces of the annular seal that may not be made using traditional machining methods. Additionally, additive manufacturing can result in a biased structure that can deform when energized, yet return to its original shape when deenergized, allowing for the annular seal to be reused multiple times.

Additive manufacturing can further allow the seal to be made with mixed materials. In this way, the material used for the sealing surfaces can be different from the material used to construct the body of the seal. For example, the sealing surface can be made of a highly corrosion resistant material while the rest of the seal is not made with highly corrosion resistant material. This can reduce the cost to manufacture the seal by not requiring the entire seal to be made from the more expensive highly corrosion resistant material. Additionally, this can prolong the life of the seal as the sealing surfaces can be more resilient to chemical attacks with the change in materials of construction.

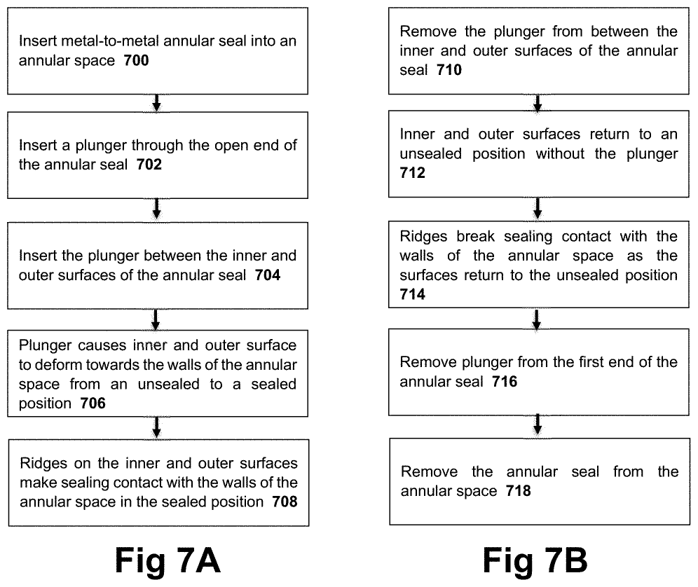

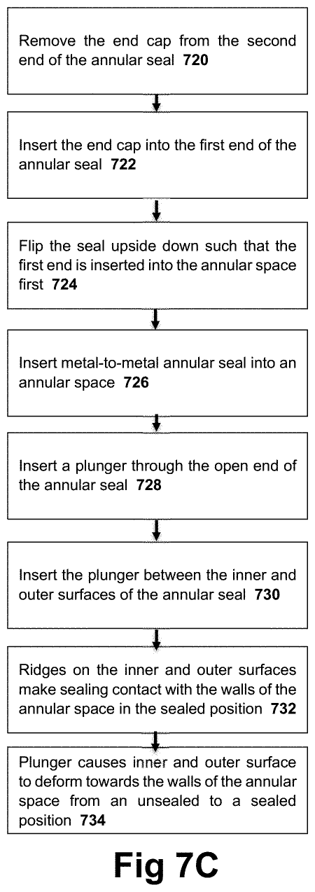

FIG. 7A is a process for temporarily sealing an annular space with a metal-to-metal annular seal. The annular seal can first be placed in the annular space at the desired sealing location in step 700. Once the annular seal is in place, a plunger is inserted into the open end of the annular seal in step 702. The open end can either be the first end towards the top of the seal, or the second end from the bottom of the seal. The plunger can continue into the recess or space between the inner and outer surfaces of the annular seal in step 704, thereby energizing the seal. The inner and outer surfaces of the annular seal can then be pushed radially outward relative to the plunger, resulting in the generally concave surfaces moving outward towards the walls of the annular space until the surfaces reach a sealed position in step 706. Ridges on the inner and outer surfaces of the seal can make sealing contact with the string and wellbore of the annular space to seal the annular space in step 708.

FIG. 7A can be modified for annular seals with multiple sealing locations. A tapered or bulbous plunger can be used to set individual seal sets within the annular seal. With at least one set of seals engaged of the annular seal, the seal can then be tested to ensure that the space is properly sealed. If the annular space is properly sealed, the seal can remain in a partially engaged state. If the annular space is not properly sealed, the method of FIG. 7A can be repeated from 704 to engage additional ridge sets on the seal until the annular space is properly sealed.

FIG. 7B is then a process for removing the temporary seal from the annular space. Here, the plunger can first be removed from the space between the inner and outer surfaces in step 710. Without the plunger pushing the inner and outer surfaces outward, they return to their original, deenergized position in step 712. This can result in the ridges on the inner and outer surfaces breaking contact with the string and wellbore of the annular space which also breaks the seal on the annular system in step 714. The plunger can then be fully removed from the first end of the seal in step 718 and the seal can be removed from the annular space in step 718.

FIG. 7C follows as a process for resealing the same location of the annular space after the seal has been removed. Replacement of the seal in the exact same orientation may not result in proper sealing of the annular space. This is because the ridges of the seal can contact the string and wellbore of the annular space in the same position. Repeated sealing in the same location can lead to wear on the string and wellbore at the location of contact which can cause incomplete sealing when installed at a later time.

For resealing the space, the end cap can first be removed from the second end of the annular seal and installed on the first end of the annular seal in steps 720 and 722. The entire seal can then be flipped such that the capped first end is inserted first into the annular space in step 724. The seal can then be reinserted and resealed in steps 726 through 734, which are similar to FIG. 7A. Reversing the orientation of the seal can result in different sealing locations due to different offsets in the ridges on the inner and outer surfaces of the seal. This results in a complete seal of the annular space even if the seal is installed in the same location as before.

For a seal with an integral end and no seal cap, steps 720 and 722 can be skipped. Instead, when the plunger is inserted into the reoriented seal in step 728, the plunger can be inserted into the open first end from below the seal instead of from above the seal. This results in the different sealing locations from reorienting the seal without having to reposition the seal cap.

Alternatively, the seal can be completely replaced with an alternative seal with sealing ridges located at different positions than the original seal. In this embodiment, replacement starts at step 726 with inserting the new seal into the annular space and proceeds according to FIG. 7C. This embodiment can be used when the sealing surfaces of the original seal are worn or if the seal has already been reoriented in the annular space.

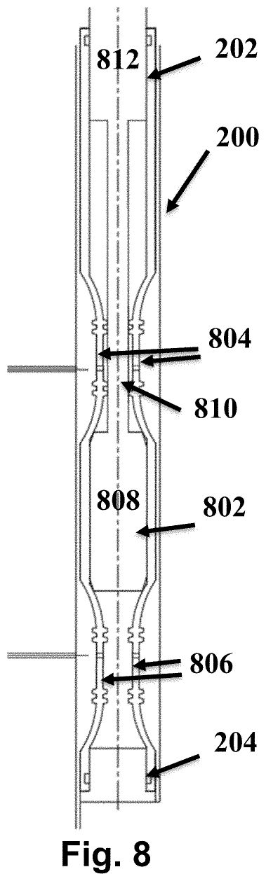

FIG. 8 is an embodiment according to the present technology of a seal 200 with a bulbous plunger 802. The seal can have upper sets of inner and outer ridges 804 and lower sets of inner and outer ridges 806. The plunger 802 in this embodiment can a lower end 808 and an upper end 812 with greater diameters than a center section 810.

This configuration of the plunger can allow for the sets of ridges 804 and 806 to be selectively engaged by the bulbous plunger 802. From the position shown in FIG. 8, the plunger can be retracted up the body of the seal 200 towards the first end 202 so that the lower end 808 is located between the upper sets of ridges 804. This can allow for the selective engagement of the upper ridge sets 804 without engaging the lower ridge sets 806. Alternatively, the bulbous plunger 804 can be inserted further into the seal 200 towards the second end 204. In this configuration, the lower set of ridges 806 can be selectively engaged while the upper set of ridges 804 may not be engaged. The shape of the bulbous plunger 802 can allow for partial and selective activation of the seal.

Other embodiments of the seal can allow for different sequences of engaging sealing surfaces depending on the configuration of the seal and plunger. A tapered plunger of FIG. 6, for example, can engage sealing ridge sets located towards the first end 202 of the seal while not engaging sealing ridge sets towards the second end 204 of the seal. Conversely, a bulbous plunger 802 as shown in FIG. 8 can engage sealing ridge sets towards the second end 204 of the seal while not engaging sealing ridge sets towards the first end 202 of the seal.

Although the technology herein has been described with reference to particular embodiments, it is to be understood that these embodiments are merely illustrative of the principles and applications of the present technology. It is therefore to be understood that numerous modifications may be made to the illustrative embodiments and that other arrangements may be devised without departing from the spirit and scope of the present technology as defined by the appended claims.

That claimed is:

1. A metal-to-metal seal for sealing between a pair of annular surfaces, the seal comprising:
a first seal end, a second seal end, and a central seal portion, the central seal portion having a concave shape in a de-energized state such that the central portion curves toward a centerline of the seal, the central portion capable of flexing radially outward toward the pair of annular surfaces upon energization of the seal; and
at least one outer ridge extending from the central portion of the seal radially outward away from the centerline of the seal so that when the seal is energized the at least one outer ridge sealingly engages an outer annular surface of the pair of annular surfaces.

2. The seal of claim 1, further comprising at least one inner ridge extending from the central portion of the seal radially outward away from the centerline of the seal so that when the seal is energized the at least one inner ridge sealingly engages an inner annular surface of the pair of annular surfaces.

3. The seal of claim 1, wherein the central seal portion comprises an outer concave central seal surface and an inner concave central seal surface, the outer concave central seal surface and inner concave central seal surface separated from one another and defining a recess therebetween, the seal further comprising at least one intra-seal ridge extending from the outer concave central seal surface into the recess so that when the seal is energized by a plunger inserted into the recess, the at least one intra-seal ridge extending from the outer concave central seal portion sealingly engages the plunger.

4. The seal of claim 3, further comprising and at least one intra-seal ridge extending from the inner concave central seal surface into the recess so that when the seal is energized by the plunger, the at least one intra-seal ridge extending from the inner concave central seal surface sealingly engages a plunger.

5. The seal of claim 3, wherein the at least one outer ridge comprises a plurality of outer ridges.

6. The seal of claim 5, wherein the plurality of outer ridges is positioned at predetermined intervals along the central portion of the seal such that when the seal is reversed in the annulus a seal profile of the seal changes.

7. The seal of claim 3, further comprising:
the plunger for insertion into the recess between the inner concave central seal surface and the outer concave central seal surface.

8. The seal of claim 7 wherein the plunger has a larger diameter than a diameter of the recess such that insertion of the plunger into the recess energizes the seal.

9. The seal of claim 1 wherein the seal is made via an additive manufacturing process.

10. The seal of claim 1 wherein the at least one ridge comprises a different material of construction than the central portion of the metal-to-metal seal.

11. A method for sealing an annular space of a well comprising:
inserting a metal-to-metal annular seal into an annular space, the metal-to-metal annular seal having an at least one inner and outer biased concave central seal surfaces;
inserting a plunger into a first end of the annular seal;
energizing the seal by pushing the at least one inner and outer biased concave central seal surfaces toward proximate annular surfaces in the annular space; and
sealingly engaging the at least one inner and outer biased concave central seal surfaces with annular surfaces in the annular space.

12. The method of claim 11 further comprising:
providing at least one intra-seal ridge and ridges on the inner and outer biased concave central seal surfaces; and
sealingly engaging the at least one intra-seal ridge with the plunger and the ridges with the annular surfaces in the annular space.

13. The method of claim 11 further comprising:
sealingly engaging at least one additional inner and outer biased concave central seal surfaces with annular surfaces in the annular space.

14. The method of claim 11 further comprising:
prior to energizing the seal, positioning the plunger in a de-energized position within the seal.

15. The method of claim 11 wherein the plunger is tapered or bulbous to selectively engage the at least one inner and outer biased concave central sealing surface.

16. A method of resealing an annular space comprising:
removing a plunger from a first end of a metal-to-metal annular seal to de-energize the metal-to-metal annular seal;
removing the metal-to-metal annular seal from the annular space;
reorienting the seal relative to the annular space;
reinserting the seal into the annular space; and
inserting the plunger into an open end of the metal-to-metal annular seal to re-energize the metal-to-metal annular seal.

17. The method of claim 16 further comprising:
moving a seal cap from a second end of the annular seal to the first end of the annular seal before the reoriented seal is reinserted into the annular space.

18. The method of claim 16 wherein the plunger is inserted into the open end of the seal from below to re-energize the seal.

19. The method of claim 16 wherein the seal is in a substantially similar location in the annular space before removal and after re-insertion.

20. The method of claim 19 wherein the ridges engage the surfaces of the annular space in a substantially different locations before removal and after re-insertion.
